(19) United States
(12) Patent Application Publication
(10) Pub. No.: US 2006/0278347 A1
(43) Pub. Date: Dec. 14, 2006

(54) Arrangement for screening-off a space

(75) Inventor: Carl Jonson, Lund (SE)

Correspondence Address: MERCHANT & GOULD PC, P.O. BOX 2903, MINNEAPOLIS, MN, 55402-0903, US

(73) Assignee: CARLSRUM DESIGN AB, Lund (SE)

(21) Appl. No.: 10/567,501

(22) PCT Filed: Aug. 31, 2004
(86) PCT No.: PCT/SE04/01245

§ 371 Date: Feb. 6, 2006

(51) Int. Cl. E06B 9/30

(52) U.S. Cl. 160/168.1 R

(57) ABSTRACT

The disclosure relates to an arrangement for screening-off a space and for preventing liquid from splashing outside the space, comprising a plurality of lamellae or slats displaceable via an operating element and having a first longitudinal side and a second longitudinal side, the slats being displaceable between a first position screening-off the space and an open, second position. The first longitudinal side of the slats is free and the slats are supported by at least one ladder disposed at the second longitudinal side, the slats being vertically displaceable via the operating element between the first position screening-off the space and the open, second position, and the slats being pivotal about an axis running along the second longitudinal side and being substantially horizontal. The slats are distributed along the ladder with a mutual spacing so that the first longitudinal side of each respective slat, in the screening-off first position, projects over the second longitudinal side of an adjacent slat.

### TECHNICAL FIELD

The present invention relates to an arrangement for screening-off a space. More specifically, the present invention relates to an arrangement for screening-off a first space from a second space and preventing liquid from splashing outside the first space. Arrangements of the type under consideration here occur in connection with the screening-off of a space in order to prevent liquid from splashing in environments where liquid splashes and the like take place. Arrangements of the type contemplated here often occur in connection with shower and bathing areas and the like. Normally, this type of arrangement occurs in a domestic environment for screening-off a shower area, such as a bathtub, shower cabinet or the like, in order to prevent water from splashing outside the shower area. This type of arrangement may also occur in connection with car wash installations, painting work, cutting processing and the like.

### BACKGROUND ART

Numerous different types of apparatuses and arrangements for screening-off a space and preventing liquid or water from splashing outside a space are previously known in the art. One such type of arrangement comprises water-repellent curtains, such as shower curtains, in order to screen-off a space in an environment where liquid splashing takes place, such as a shower area, bathtub or the like. Normally occurring shower curtains are produced from a liquid-repellent material and are, in their upper end, moveably connected to a horizontal rod, in which event the shower curtain may be drawn along the rod. In order to screen off the shower area, the shower curtain is moved in front of an opening between the shower area and adjacent space and, when the shower curtain is not in use, it may be moved to the side while at the same time being folded.

Another type of such prior art arrangement is disclosed in U.S. Pat. No. 6,412,124. The arrangement according to this document comprises a shower curtain consisting of a plurality of mutually interconnected lamellae or slats which run in a groove disposed in a ceiling so that the salts can be moved sideways between a screening-off position and an open position.

One drawback in such prior art arrangements for preventing liquid from splashing outside the space is that they are bulky and take up considerable space when not in use. For example, a shower curtain or other types of water-repellent curtains which are moved to the side take up relatively large space in an area such as a bathroom, which also entails that the area in question is perceived as being smaller.

One problem inherent in such prior art arrangements is that they become damp after use and subsequently dry slowly. A water-repellent curtain becomes wet or attracts moisture when in use, whereafter it is often moved to the side after use, during simultaneous folding, with the result that it takes a considerable time for the curtain to dry.

A further problem inherent in such prior art arrangements is that there is a risk of mould damage or the like to such arrangements after a period of use.

### BRIEF OUTLINE OF THE INVENTION

One object of the present invention is to obviate the above-outlined drawbacks and problems inherent in prior art solutions. The arrangement according to the present invention entails that liquid splashing from an area such as a shower area or other environment where liquid splashing may occur can be avoided in a reliable and simple way without taking up unusually large space or without being in the way when not in use. Hence, the arrangement according to the present invention entails that a first space where liquid splashing occurs may be screened-off from a second space, the second space being protected against liquid splashing.

Still a further object of the present invention is to realise a liquid-repellent Venetian blind or louvre which may advantageously be employed for screening-off a space where liquid splashing occurs.

Yet a further object of the present invention is to realise a liquid-repellent apparatus in the form of a Venetian blind or louvre including at least one ladder, where the ladder is protected from splashing liquid while at the same time an arrangement is realised which is effective against splashing liquid.

According to one embodiment of the present invention, an arrangement of the type contemplated here will be realised which is simple to mount in position.

According to one embodiment of the present invention, there will be realised an arrangement which remains in the desired position and, for example, is not sucked in towards a person in a shower area. This problem occurs in connection with prior art arrangements as a result of the fact that the water in the shower area heats up the air in the shower area, whereafter the air rises. Consequently, cold air outside the shower area is drawn in towards the shower area while entraining the arrangement towards the person in the shower area.

The present invention comprises an arrangement for screening-off a space and for preventing liquid from splashing outside the space, and comprising a plurality of lamellae or slats displaceable by the intermediary of an operating element and having a first side, a second side, short sides, a first longitudinal side and a second longitudinal side, the slats being displaceable between a first position screening-off the space and an open second position, characterised in that the first longitudinal side of the slats is free and that the slats are supported by at least one ladder disposed at the second longitudinal side, the slats being, by the intermediary of the operating element, displaceable between the first position screening-off the space and the open second position, and the slats being rotary about an axis running along the second longitudinal side and being substantially horizontal, and that the slats are distributed along the ladder with a mutual spacing such that the first longitudinal side of each respective slat in the screening-off first position projects over the second longitudinal side of an adjacent slat.

Thus, the arrangement according to the present invention may be designed as a liquid-repellent Venetian blind or a liquid-repellent louvre which may be employed in connection with screening-off a space such as a space where liquid splashing occurs. Examples of such spaces are bathing areas, shower areas, washing installations and areas where paintwork, cutting processing and similar operations occur. According to one embodiment of the present invention, the arrangement is thus designed as a shower Venetian blind or shower louvre.

The ladder may run through a recess in each respective slat, the recess being disposed at the second longitudinal side of the slats, or between a centre line of the slat and the second longitudinal side of the slat so that the short side of the slat automatically assumes a substantially vertical position in the lowered, screening-off first position. Alternatively, the ladder may be connected directly to the slat. The recess may be designed as a recess which projects into the slat so that the ladder may be passed into the recess and support the slat. Further, the operating element may include one or more lifting cords which run through an aperture in each respective slat so that the arrangement may be lowered to the screening-off position and raised to the open position. The recess and the aperture may be disposed in the slat or in an element connected to the slat.

The ladder may comprise a cord and abutment portions for abutment against the slats. The abutment portions may comprise abutments projecting transversely of the extent of the ladder in order to support the slats. The abutments may consist of balls, knots, washers or the like which abut against the second side of the slats in order to support the slats. The abutment may be designed to be snapped in position in a groove provided in the slat and corresponding to the abutment. The ladder may support each respective slat in that it is passed into the recess from the one longitudinal side of the slat so that the abutment lies in contact with the second side of the slat, which results in simpler and less time-consuming mounting operation. Alternatively, the abutment portions may include a fixed connection between the slats.

A plurality of abutment portions or abutments may be distributed along the ladder with a mutual spacing which is less than the width of each respective slat so that the first longitudinal side of each respective slat in the screening-off first position projects over the recess in the second longitudinal side of an adjacent slat. Thus, the slats may be distributed along the ladder with a mutual spacing which is less than the width of each respective slat so that the first longitudinal side of each respective slat projects over the second longitudinal side of an adjacent slat. By such means, an overlap may be created which affords a more reliable barrier against splashing liquid. Further, the first longitudinal side of each respective slat may project over apertures and recesses for lifting cords and ladders, respectively, in the second longitudinal side of an adjacent slat, the apertures and recesses as well as the lifting cords and ladders being covered by a superjacent and adjacent slat in a lowered screening-off position. By such means, liquid is prevented from passing the apertures and the recesses. Further, lifting cords and ladders are protected from splashing liquid, a screening-off arrangement which effectively repels splashing liquid being realised. Hence, the arrangement according to the present invention entails that the slats overlap each other's recesses for the ladder and apertures for the lifting cord. The reason for the overlap is that the slats should, in the lowered screening-off position, be tight and protect the ambient surroundings from splashing liquid. At the same time, no cords such as the ladder or lifting cord, should be exposed to liquid. This is achieved in that the ladder only supports or is secured to one longitudinal side of the slat and that the slats, in the lowered position, overlap each other's recesses for the ladder and apertures for the lifting cord. Alternatively, the ladder and lifting cord are disposed at the short sides of the slats, in which event the cords may be exposed to wet but otherwise give a liquid-tight barrier against splashing liquid.

The slats may include a projecting portion for abutment against an adjacent slat in the open, second position while forming an air gap between adjacent slats. By such means, it will be ensured that the slats dry in the raised position. Further, the projecting portion prevents the slats from sticking together in the open, second position when the slats are wet. The projecting portion may be disposed at the second longitudinal side of each respective slat. The projecting portion may project from the first side of the slat and may be provided with a curve in order to prevent liquid splashing from beneath. Alternatively, the projecting portion may project from the second side of the slat.

According to one embodiment of the invention, the slats may, in the screening-off position, be provided with a gap between adjacent slats so that air may pass between the slats in the arrangement. By such means, it will thus be prevented, for example, that the arrangement is sucked in towards a shower space and a person in the shower space. The gap may be disposed between the lower longitudinal side of an upper slat and one side of a subjacent slat which is directed in towards the shower space, the slats overlapping one another so that liquid which splashes substantially from above cannot pass through the gap. The gap may be realised in that the slats are urged forwards slightly by the lifting cord or the ladder. For example, the slat may include a curve which is designed for abutment against the lifting cord and/or the ladder so that these, in the screening-off first position, urge the slats forward so that they are angled slightly in towards the shower space. Further, the curve may be designed so as to reduce wear on the lifting cord and ladder.

Further characterising features and advantages inherent in the present invention will be apparent from the description of preferred embodiments below, appended Drawings and dependent Claims.

### BRIEF DESCRIPTION OF THE ACCOMPANYING DRAWINGS

The present invention will now be described in greater detail hereinbelow, with the aid of preferred embodiments and with reference to the accompanying Drawings. In the accompanying Drawings:

FIG. 1 is a schematic perspective view of the arrangement according to one embodiment of the present invention in the screening-off position, seen from one side where splashing liquid occurs or a first side of the arrangement;

FIG. 2 is a schematic perspective view of the arrangement according to FIG. 1 in the screening-off position, seen from a side opposite that of FIG. 1 or a second side of the arrangement;

FIG. 3 is a schematic view of one end portion of a slat according to one embodiment of the present invention showing the recess and aperture of the slat for the ladder and lifting cord, respectively;

FIG. 4 is a schematic view of an end portion of a slat according to one alternative embodiment of the present invention, showing the recess and the aperture of the slat for the ladder and lifting cord, respectively;

FIG. 5 is a schematic view of an end portion of a slat according to an alternative embodiment of the present invention showing the recess and the aperture of the slat for the ladder and the lifting cord, respectively;

FIG. 6 is a schematic view of an end portion of a slat according to an alternative embodiment of the present invention showing the recess and aperture for the ladder and lifting cord, respectively;

FIG. 7 is a schematic view of an end portion of a slat according to an alternative embodiment of the present invention showing the recess and aperture for the ladder and lifting cord, respectively;

FIG. 8 is a schematic perspective view of a slat according to one embodiment of the present invention;

FIG. 9 is a schematic side elevation of the slat according to FIG. 8;

FIG. 10 is a schematic view of the slat according to FIG. 8 seen from above;

FIG. 11 is a schematic side elevation of a plurality of cooperating slats according to FIG. 8 in the lowered, screening-off position;

FIG. 12 is a schematic side elevation of a ladder according to one embodiment of the present invention;

FIG. 13 is a schematic side elevation of a plurality of cooperating slats according to FIG. 8 in the raised, open position;

FIG. 14 is a schematic side elevation of a plurality of cooperating slats according to an alternative embodiment of the present invention in the lowered, screening-off position; and

FIG. 15 is a schematic side elevation of a plurality of cooperating slats according to FIG. 14 in the raised, open position.

### DESCRIPTION OF PREFERRED EMBODIMENTS

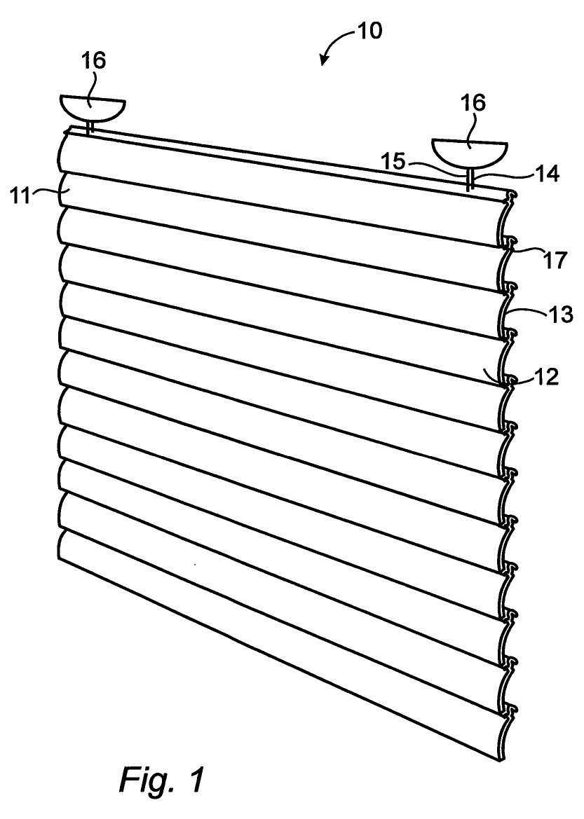

With reference to FIG. 1 and FIG. 2, there is schematically shown an arrangement 10 for screening-off a space according to one embodiment of the present invention. The arrangement 10 is designed to screen-off a first space from a second space and prevent liquid from splashing outside the first space. For example, the arrangement 10 is designed to screen-off a space where liquid splashing occurs, such as different types of washing installations or spaces where different types of work involving liquids or the like occur. For example, the arrangement 10 is designed, in connection with showering, to prevent water from splashing outside the shower area. According to one embodiment of the present invention, the arrangement 10 is thus designed to be mounted between a first space, such as a shower area, bathtub or the like, and an adjacent second space, such as the remainder of a bathroom or the like. Preferably, the arrangement 10 is designed to be mounted in an upper region of the first space so that the arrangement depends down from a ceiling or the like, in which event the arrangement 10 may be moved between a lowered first position screening-off the first space and a raised, open second position. For example, the arrangement 10 is designed to be mounted between a ceiling and a floor or an edge of a bathtub or the like. For example, the arrangement 10 is designed as a liquid-repellent Venetian blind or louvre or a shower Venetian blind or a shower louvre.

The arrangement 10 includes a liquid-repellent element in the form of a plurality of cooperating lamellae or slats 11 in order to prevent liquid from splashing out of the first space. The slats 11 are elongate and comprise a first side 12 and a second side 13. The first side 12 is, in the illustrated embodiment, designed in order, in the screening-off first position, to be directed substantially towards the first space, such as a shower area, and, in the open second position, to be directed more upwards or obliquely upwards so that the slats 11 incline somewhat. Thus, the first side 12 of the slat 11 is, in the screening-off first position, disposed substantially vertically in a direction towards the first space, since an axis along the extent of the slat is horizontal. In the open, second position, the first side 12 of the slat 11 is disposed obliquely upwards, since the axis along the extent of the slat is still horizontal. For example, the slat 11 in the open second position is disposed with an inclination so that liquid on the slat runs off. The second side 13 is designed, in the screening-off first position, to be directed substantially towards a second space adjacent the first space, such a space adjacent the shower area, and, in the open second position, to be directed more downwards or obliquely downwards. Thus, the second side 13 of the slat 11 is, in the screening-off first position, disposed substantially vertically in a direction opposite to that of the first space, since an axis along the extent of the slat 11 is horizontal. In the open, second position, the slat 11 is angled in towards the first space, the second side 12 having been rotated in a direction towards the horizontal position, since the axis along the extent of the slat is still horizontal.

For example, the slats 11 are manufactured from a liquid-repellent plastic material which is preferably resistant to chlorine, soaps, acids, heat, impact and the like. For example, the slats 11 are manufactured of polycarbonate plastic, acrylic plastic such as PMMA, thermoplastic, such as PET/PETG, or PVC, aluminium or the like.

The slats 11 are supported by or mutually interconnected via one or more ladders 14 which are disposed in recesses in the slats 11, the recesses being described in greater detail below. The ladder 14 includes abutment portions for abutment against each respective slat 11. The ladder 14 is disposed substantially vertically and transversely of the extent of the slats 11. Further, the ladder 14 is disposed along one longitudinal side or edge of each respective slat 11 so that the first side 12 and second side 13 of the slats 11 in the screening-off first position automatically assume a substantially vertical position. For example, the arrangement 10 includes two ladders 14 which are distributed along one longitudinal side or edge of each respective slat 11.

With the aid of an operating element, the slats 11 may be manoeuvred from the screening-off first position to the open second position. For example, the operating element comprises one or more lifting cords 15 which are disposed so that each respective slat 11 is displaceable between the screening-off first position and the open, second position during simultaneous pivoting about an axis extending along the extent of the slat 11. The lifting cord 15 suitably runs through an aperture in each respective slat 11 and through a locking housing so that the arrangement 10 may be fixedly locked in the open, second position. For example, the locking housing is a conventional locking housing for Venetian blinds and will not be described in greater detail. The lifting cord 15 is disposed at the same longitudinal side or edge of each respective slat 11 as the ladder 14. For example, the arrangement 10 includes two lifting cords 15.

According to one embodiment of the present invention, the ladder 14 and the lifting cord 15 are connected to a cap 16, the lifting cord running through the cap 16. The cap 16 is designed to be fixed in a ceiling or the like for suspending the arrangement 10. For example, the locking housing of the lifting cord 15 is disposed in the cap 16. Alternatively, the arrangement is suspended in a conventional coving.

The slats 11 are designed in such a manner that they may dry in the open, second position, i.e. in the raised position, without fastening in adjacent slats or sticking together. The first side 12 or the second side 13 of each respective slat 11 includes or is provided with at least one projecting portion 17 for abutment against the second side 13 or the first side 12 of an adjacent slat 11 in the open, second position while forming at least one air gap between adjacent slats 11.

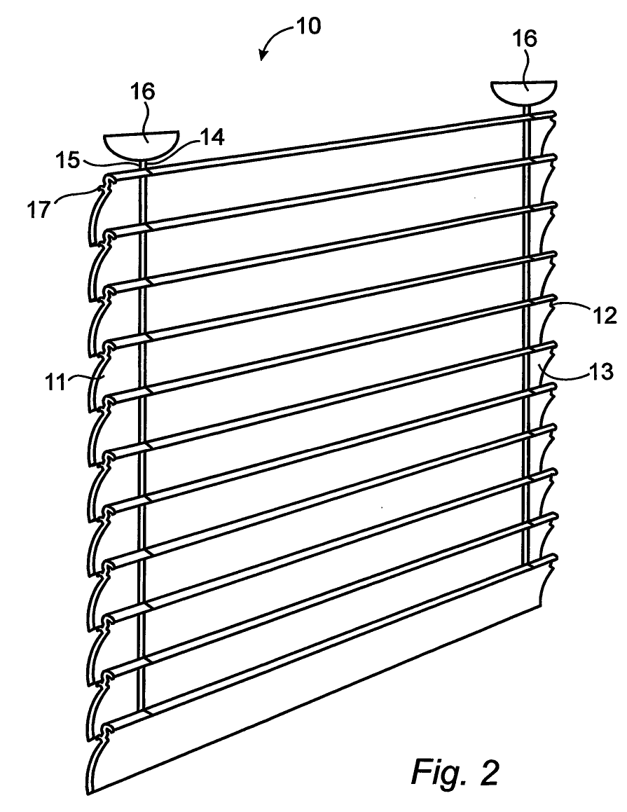

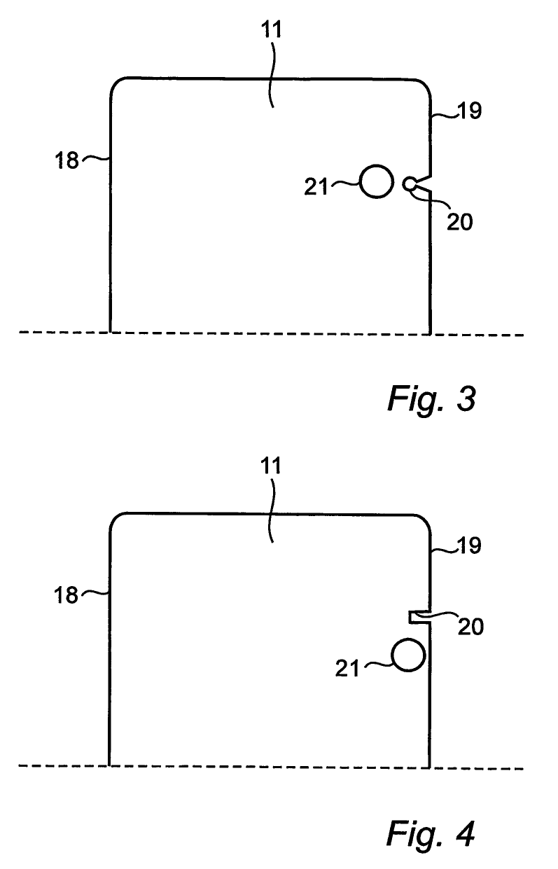

With reference to FIG. 3, there is shown an end portion of a slat 11 according to one embodiment of the present invention. Each respective slat 11 includes a first longitudinal side 18 and a second longitudinal side 19, as well as at least one recess 20 for the ladder 14 and at least one aperture 21 for the lifting cord 15. The slats 11 are supported by the ladder 14 running through the recess 20 in each respective slat 11. In the embodiment illustrated in FIG. 3, the recess 20 is disposed at the second longitudinal side 19 of the slat 11, the slat 11 being supported in the second longitudinal side 19, while the first longitudinal side 18 is free. The recess 20 projects into the slat 11 as a recess in and transversely of the second longitudinal side 19 of the slat 11 so that the ladder 14 may be passed in to the recess 20 from the second longitudinal side 19.

The recess 20 is designed to be larger than the cord of the ladder 14 but smaller than the abutments, such as balls, projecting transversely of the extent of the ladder 14, so that the ladder 14 may be passed into the recess 20 and the abutment abut against the second side 13 of the slat 11. For example, the recess 20 is of a width which is greater most proximal the longitudinal side 19 than further in, thus facilitating the insertion of the ladder 14. In the embodiment illustrated in FIG. 3, the recess 20 is in the form of a triangle which, at its apex, is terminated by an open area which is circular, rectangular, oval or the like, in which event the ladder 14 may be passed into the triangular area and further into the open area. For example, two or more recesses 20 are distributed along the second longitudinal side 19 of the slat 11 for accommodation of two or more ladders 14.

In the embodiment illustrated in FIG. 3, the aperture 21 for the lifting cord 15 is disposed inside the recess 20. Alternatively, the recess 20 is disposed inside the aperture 21 and/or designed in a manner corresponding to the aperture 21. Alternatively, the aperture 21 is integral with the recess 20, in which event the lifting cord 15 is prevented from unintentionally leaving the aperture 21 in that the ladder 14 blocks the mouth of the recess. The aperture 21 is, for example, circular, rectangular, oval or the like and is designed so that the lifting cord may readily run therethrough. For example, two or more apertures 21 are distributed along the second longitudinal side 19 or the slat 11 for accommodating two or more lifting cords 15.

With reference to FIG. 4, an end portion of a slat 11 is shown according to an alternative embodiment of the present invention. In the embodiment illustrated in FIG. 4, the recess 20 and the aperture 21 are disposed at the second longitudinal side 19 of the slat 11, the aperture 21 being disposed beside the recess 20 so that the lifting cord 15 is disposed at substantially the same distance from the second longitudinal side 19 as the ladder 14. In the illustrated embodiment, the recess 20 is a rectangular recess in the second longitudinal side 19 of the slat and the aperture 21 is, for example, circular.

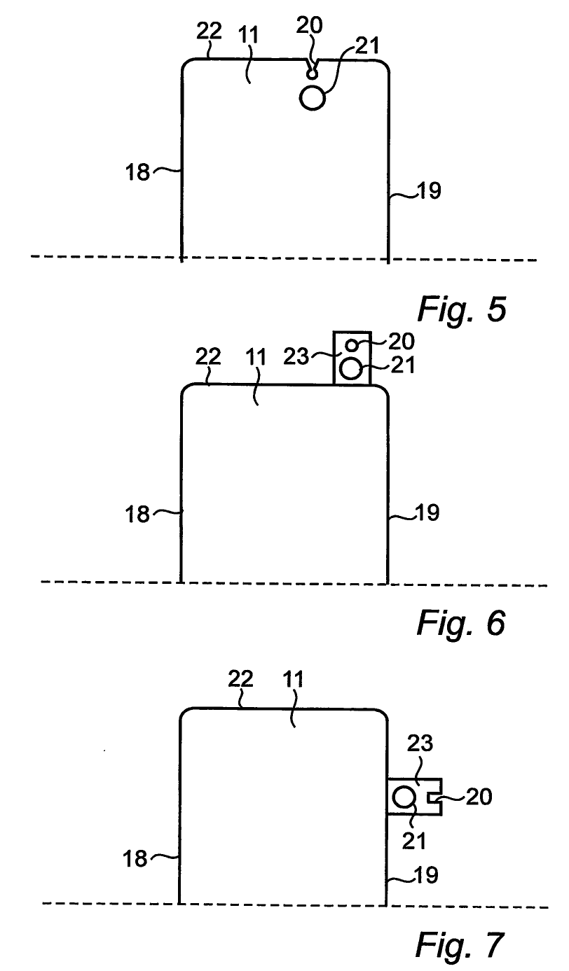

With reference to FIG. 5, there is shown an end portion of a slat 11 according to an alternative embodiment of the present invention. In the embodiment illustrated in FIG. 5, the recess 20 and the aperture 21 are disposed in one short side 22 of the slat 11, in a position between an imaginary centre line of the slat 11 and the second longitudinal side 19 of the slat 11 so that the short sides 22 of the slat 11 automatically assume, in the screening-off first position, a substantially vertical position. Thus, the recess 20 and the aperture 21 are disposed in a direction towards, or at, the second longitudinal side 19 of the slat 11, while the first longitudinal side 18 is free. The aperture 21 is disposed inside the recess 20 so that the lifting cord 15 is disposed at substantially the same distance from the second longitudinal side 19 as the ladder 14. Alternatively, the aperture 21 is disposed beside the recess 20. Suitably, a set of recesses 20 and apertures 21 is disposed at each respective short side 22 of the slat 11.

With reference to FIG. 6 and FIG. 7, there is shown an end portion of a slat 11 according to alternative embodiments of the present invention. In the embodiments illustrated in FIGS. 6 and 7, the recess 20 and the aperture 21 are disposed in an element 23 connected to the slat 11. The element 23 projects from the short side 22 of the slat 11 or the second longitudinal side 19. The element 23 extends along a portion of the short side 22 of the slat 11 or second longitudinal side 19. Alternatively, the element 23 extends along the entire short side 22 of the slat 11 or the second longitudinal side 19. Since the element 23 is connected to the short side 22, the element 23 is disposed in a position at the second longitudinal side 19, i.e. in a position between an imaginary centre line of the slat 11 and the second longitudinal side 19, so that the short side 22 of the slat 11 automatically assumes a substantially vertical position in the screening-off first position of the arrangement 10. For example, the element 23 is integral with the slat 11. Alternatively, the element 23 is fixedly or removably connected to the slat 11. Thus, the recess 20 and the aperture 21 are disposed in a direction towards, or at, the second longitudinal side 19 of the slat 11.

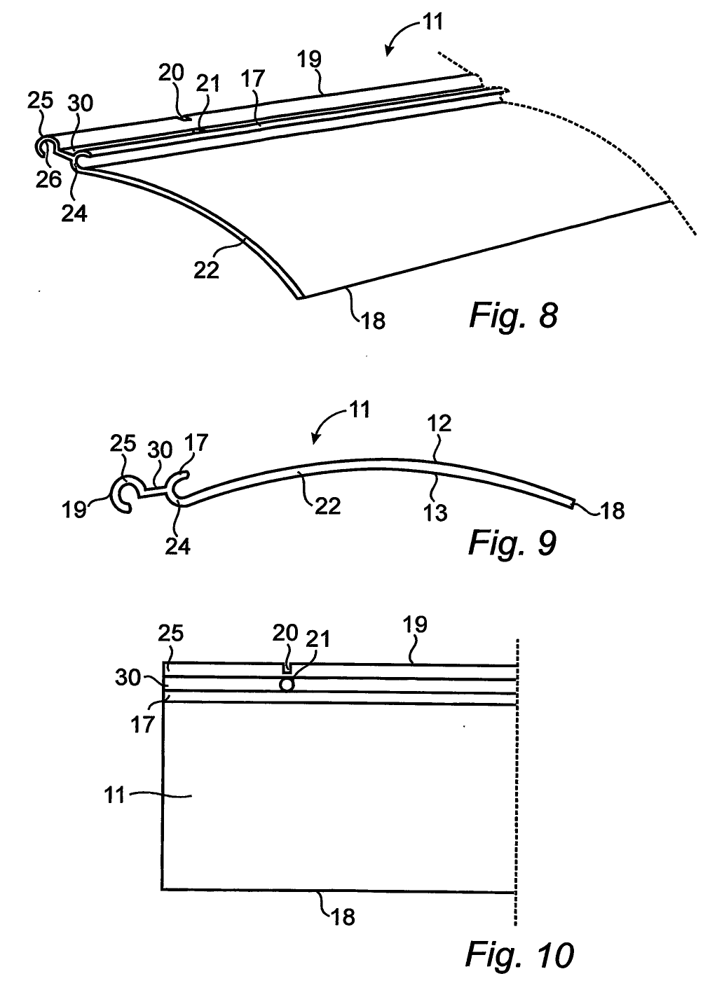

With reference to FIGS. 8-10, there is shown a schematic perspective view of a part of a slat 11, a schematic side elevation of a slat 11, and a view of the first side 12 of the slat 11 according to one embodiment of the present invention, respectively. The slat 11 includes the first side 12, the second side 13, the projecting portion 17, the first longitudinal side 18, the second longitudinal side 19, the recess 20, the aperture 21 and short sides 22.

The projecting portion 17 is designed for abutment against an adjacent slat 11 in order to form an air gap between adjacent slats 11 so that the slats 11 may dry in the raised position, i.e. in the open, second position, as will be described in greater detail below. The projecting portion 17 extends along the extent of the slat 11, i.e. from a first end of the slat 11 to an opposing, second end thereof. In the illustrated embodiment, the slat 11 is designed with a first bend 24 which forms the projecting portion 17 and a second bend 25 which forms a groove 26 for the abutment portion of the ladder 14 so that the ladder 14 may be connected to the slat 11. The first bend 24 is designed with a curvature in a direction towards the first side 12 of the slat 11 and is also designed to take up splashing liquid from beneath when the arrangement 10 is in the screening-off first position. The second bend 25 is designed with a curvature in a direction towards the second side 13 of the slat 11, i.e. in a direction opposed to that of the first bend 24. A planar portion 30 interconnects the first bend 24 and the second bend 25, the planar portion 30 extending between a central portion of the first bend 24 and the second bend 25. The first bend 24 is thus divided into a first portion in a direction towards the first side 12 and a second portion in a direction towards the second side 13. The slat 11 is further designed with a smaller curvature in a direction transversely of the extent of the slat 11 so that the profile of the slat 11 is slightly bent. Alternatively, the slat 11 is planar.

The recess 20 for the ladder 14 is disposed at the second longitudinal side 19 of the slat 11 and is designed as a recess which projects into the second bend 25, the ladder 14 extending through the recess 20, while the abutment portion of the ladder 14 is disposed in the groove 26 and abuts against the second bend 25 on the second side 13 of the slat 11. Thus, the recess 20 is designed for accommodating the abutment portion of the ladder 14 for connection of the ladder 14 to the slat 11. The aperture 21 for the lifting cord 15 is, in the illustrated embodiment, disposed between the first bend 24 and the second bend 25, i.e. in the planar portion 30 inside the recess 20. Alternatively, the aperture 21 is integral with the recess 20 while forming a deeper recess for accommodating both the lifting cord 15 and the ladder 14, the lifting cord 15 being prevented from unintentionally leaving the recess in that the ladder 14 blocks the mouth of the recess.

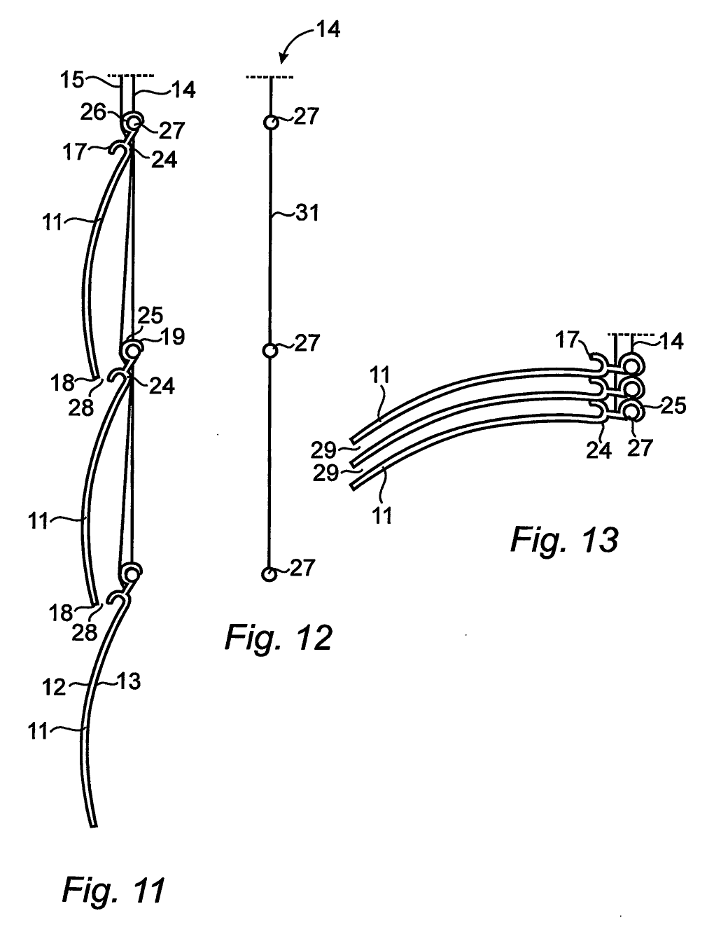

With reference also to FIGS. 11-13, there are shown, according to one embodiment of the present invention, a plurality of mutually interconnected slats 11 in the lowered, screening-off first position, the ladder 14 and a plurality of mutually interconnected slats 11 in the raised open, second position. The slats 11 are supported by or mutually interconnected via at least one and suitably two or more ladders 14 and are vertically displaceable by an operating element, such as, at least one lifting cord 15. The ladder 14 abuts against the slat 11 at the second longitudinal side 19. By such means, the short sides 22 of the slats 11 automatically assume a substantially vertical position when the arrangement 10 is lowered to the screening-off first position. The first longitudinal side 18 of the slat 11 is free from ladders 14 and lifting cords 15. Thus, the slats 11 are pivoted so that their ends, or short sides 22, are pivoted from an angled or substantially horizontal position to a substantially vertical position when the arrangement 10 is brought to the screening-off first position. A substantially vertical position implies a gentle inclination of the slat 11 where the first longitudinal side 18 is somewhat displaced towards the first space in relation to the second longitudinal side 19. Thus, the first longitudinal side 18 is disposed substantially beneath the second longitudinal side 19 in the screening-off first position. When the slats 11 are displaced between the screening-off first position and the open, second position, the slats 11 are rotated about the abutment portions of the ladders 14 so that they are rotated substantially about a horizontal axis which runs along the second longitudinal side 19 of the slats 11. This pivoting is caused when the slats 11 are moved together into abutment with each other.

In the lowered and screening-off first position, the slats 11 are disposed so that the first longitudinal side 18 of the slat 11 projects out over the second longitudinal side 19 of an immediately subjacent slat, an overlap being realised. Thus, a first slat 11 partly covers a subjacent second slat 11 so that the recesses and apertures for ladders 14 and lifting cords 15, respectively, are covered so as to avoid liquid splashes from passing through them. Further, the mutual overlapping of the slats 11 entails that the ladders 14 and lifting cords 15 are covered and protected from liquid at the same time as the first bend 24 protects against liquid splashing from beneath. This overlapping is realised in that the slats 11 are distributed along the ladder 14 with a mutual spacing which is less than the width of the slats 11. Hence, the overlapping is realised by disposing abutment portions of the ladder 14 at mutual spacing which is less than the distance between the first longitudinal side 18 and second longitudinal side 19 of the slats 11. In the embodiment of the present invention illustrated in FIG. 11-13, the abutment portions of the ladder 14 are designed as projections 27, such as balls, tubes, cylindrical knots, washers or the like projecting transversely of the extent of the ladder 14. Consequently, the overlapping will be realised in that the abutments 27, which are distributed along the ladders 14 and on which the slats 11 rest, are disposed at a mutual spacing which is less than the distance between the first longitudinal side 18 and the second longitudinal side 19 of the slats 11. Hence, the ladder 14 includes a cord 31 and abutments 27 projecting transversely of the extent of the ladder so as to support the slat 11. The groove 26 formed as a result of the second bend 25 is designed for accommodating and partially surrounding the abutment 27, in which event the abutment 27, in the form of a ball, a tube, a cylinder or the like, is snapped in position in the groove 26 for connecting the slats 11 with the ladder 14.

The first longitudinal side 18 of the slats 11 is, in the screening-off first position, free and disposed with a distance to the first side 12 of a subjacent slat 11 while forming a gap 28 between the second side 13 of a slat 11 and the first side 12 of a subjacent slat 11. Thus, air may pass between the first space and the second space in order to prevent the arrangement 10 being sucked into the shower area on showering or the like. For example, warm air in the first space may pass from the first space to the second space through the gaps 28 in an upper portion of the arrangement 10, i.e. in a direction from the first side 12 of the slats 11 to the second side 13 of the slats 11, in which event cool air from the second space may pass from the second space to the first space through the gaps 28 in a lower region of the arrangement 10. The gap 28 is realised in that the first free longitudinal side 18 of the slats 11 is slightly angled in towards the first space in the lowered, first position.

The lifting cord 15 abuts against the second bend 25, runs through the aperture 21 and abuts against the first bend 24, or the second portion of the first bend 24 which is directed towards the second side 13, so that the lifting cord 15 slides against rounded portions in order to prevent wear to the lifting cord 15. Thus, the second bend 25 and the first bend 24 are designed for abutment against the lifting cord 15. Further, the first bend 24, or the second portion of the first bend 24 which is directed towards the second side 13, may be designed for abutment against the ladder 14 in order to reduce wear thereto. For example, the lifting cord 15 and/or the ladder 14 abut against the bend 24, 25 of the slat 11 in such a manner that the lifting cord 15 and/or the ladder 14 urge the slat 11 to a slightly angled position in order to realise the gap 28, the slat 11 being angled in towards the first space so that the first longitudinal side 18 of the slat 11 is slightly displaced in towards the first space in relation to the second longitudinal side 19 of the slat 11.

With the aid of the operating element, such as one or more lifting cords 15, the slats 11 are displaced from the screening-off first position to the open, second position, the slats 11 being displaced upwards, brought together and pivoted to an angled or substantially horizontal position, as illustrated in FIG. 13. Thus, the first side 12 of the slats 11 is rotated upwards from a position where they form a liquid-repellent barrier against the first space. For example, the slats 11 incline somewhat in towards the first space in the open, second position. Alternatively, the slats 11 are substantially horizontal so that the first side 12 is directed upwards in the open, second position. In the raised, open, second position, the portion 17 projecting from the first side 12 of the slats 11 in the form of the first bend 24 abuts against the second side 13 of a superjacent slat 11 while forming an air gap 29 therebetween. The first portion of the first bend 24 which projects from the first side 12 of the slat 11 abuts, in the raised, open, second position, against the second portion of the first bend 24 at a second side 13 of an adjacent slat 11. Thus, the air gap 29 is formed as a result of the design of the projecting portion 17 or the slats 11, in which event the slats 11, in the raised and open, second position, may rapidly dry without sticking together. The projecting portion 17, and consequently the air gap 29, extend from the first longitudinal side 18 of the slats 11 to the projecting portion 17 at the second longitudinal side 19 of the slats 11. According to one embodiment of the present invention, one side of the second bend 25 at the first side 12 of the slat 11 is designed for abutment against an opposing side of a second bend 25 of a superjacent slat 11 in the second, open position of the arrangement. Alternatively, the second bend 25 is designed for abutment against the ball 27 which connects the ladder 14 to a superjacent slat 11.

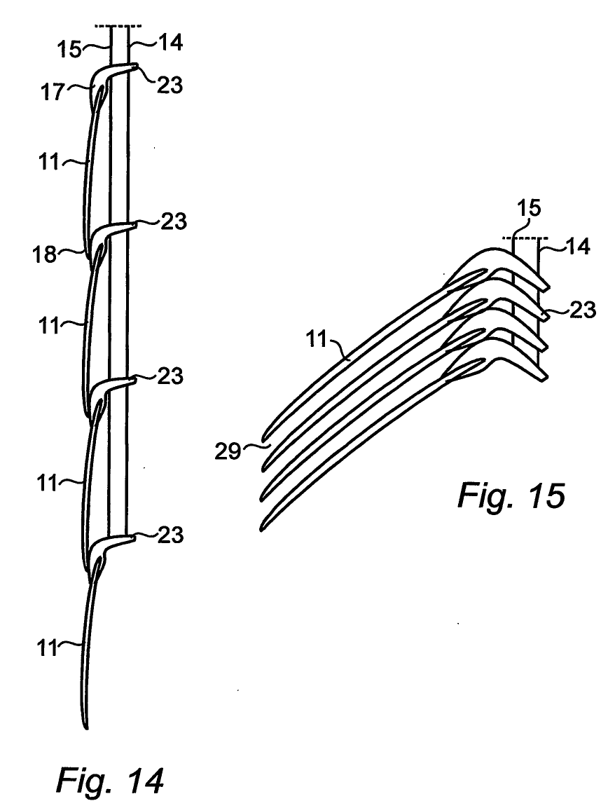

With reference to FIG. 14 and FIG. 15, there are shown a plurality of cooperating slats 11 according to an alternative embodiment of the present invention in the lowered, screening-off first position and in the raised, open, second position, respectively. In the embodiment illustrated in FIGS. 14 and 15, the slats 11 are provided with elements 23, the element 23 being disposed at the second longitudinal side 19 of the slat 11. The ladder 14 abuts against the element 23 and the lifting cord 15 runs through the aperture 21 in each respective slat 11. The ladder 14 includes abutment portions for supporting each respective slat 11 via the element 23. The abutment portions include, for example, direct anchorage, the ladder 14 being directly connected to the slat 11 or the element 23. For example, the ladder 14 is manufactured of plastic material which is injection moulded, melted or fused to the slat 11 or the element 23. For example, the element 23 is manufactured of plastic material. Alternatively, the abutment portions comprise abutments projecting transversely of the extent of the ladder 14, as described above.

In the embodiment illustrated in FIG. 14 and FIG. 15, the slats 11 overlap one another in the screening-off first position in order to realise a tight and liquid-repellent barrier, in that the abutment portions of the ladder 14 are distributed along the ladder 14 with a spacing which is less than the width of the slat 11 or, when the element 23 extends along the entire second longitudinal side 19 of the slat 11, a distance which is less than the total width of the slat 11 and the element 23. In the screening-off first position, the edge portion of the slat 11 abuts at the first longitudinal side 18 against the projecting portion 17 of a subjacent slat while forming a tight and liquid-repellent barrier. In the embodiment illustrated in FIGS. 14 and 15, the element 23 includes the projecting portion 17 in the form of a thicker portion of the element 23 which, in the open, second position, forms the air gap 29.

1. An arrangement for screening-off a space and preventing liquid from splashing outside the space, comprising a plurality of lamellae or slats displaceable via an operating element, and having a first side, a second side, short sides, a first longitudinal side and a second longitudinal side, the slats being displaceable between a first position screening-off the space and an open, second position,
comprised in
that the first longitudinal side of the slat is free; and that the slats are supported by at least one ladder disposed at the second longitudinal side the slats being vertically displaceable via the operating element between the first position screening-off the space and the open, second position, and the slats being pivotal about an axis which extends along the second longitudinal side and is substantially horizontal; and
that the slats are distributed along the ladder with a mutual spacing such that the first longitudinal side of each respective slat, in the screening-off first position, projects over the second longitudinal side of an adjacent slat.

2. The arrangement as claimed in claim 1, wherein the ladder runs through a recess in each respective slat, the recess being disposed at an edge portion of the second longitudinal side of the slats.

3. The arrangement as claimed in claim 2, wherein the recess projects in to the slat and is designed as a recess in and transversely of the second longitudinal side of the slat, so that the ladder may be moved into the recess from the second longitudinal side.

4. The arrangement as claimed in claim 1, wherein the ladder includes abutments projecting transversely of the extent of the ladder for supporting the slats.

5. The arrangement as claimed in claim 4, wherein a plurality of abutments are distributed along the ladder with a mutual spacing which is less than the width of each respective slat so that the first longitudinal side of each respective slat in the screening-off first position, projects over the recess in the second longitudinal side of an adjacent slat.

6. The arrangement as claimed in claim 5, wherein the abutment is designed to be snapped in position in a groove provided in the slat and corresponding to the abutment.

7. The arrangement as claimed in claim 1, wherein the slats include a projecting portion for abutment against an adjacent slat in the open, second position while forming an air gap between adjacent slats.

8. The arrangement as claimed in claim 7, wherein the projecting portion is disposed at the second longitudinal side of each respective slat.

9. The arrangement as claimed in claim 7, wherein the projecting portion is designed with a curvature so as to prevent liquid splashing from beneath.

10. The arrangement as claimed in claim 1, wherein the slat includes a bend designed for abutment against the operating element so as to prevent wear thereto.

11. The arrangement as claimed in claim 1, wherein the screening-off first position is a raised position and the open, second position is a lowered position.

12. The arrangement as claimed in claim 1, wherein the first space is a shower or bathing area.

13. The arrangement as claimed in claim 1, wherein the arrangement is a liquid-repellent Venetian blind or louvre.

14. The arrangement as claimed in claim 1, wherein the arrangement includes a cap connected to the slats, the cap including a locking housing for locking the slats in the open, second position
